(19) United States
(12) Patent Application Publication
(10) Pub. No.: US 2003/0011197 A1
(43) Pub. Date: Jan. 16, 2003

(54) Wind (Water) turbine with centrifugal weight control

(76) Inventor: Matthew Earley, Allenwood, NJ (US)

Correspondence Address: Matthew Earley, 3226 Atlantic Ave, PO Box 213, Allenwood, NJ, 08720, US

(21) Appl. No.: 10/091,088

(22) Filed: Mar. 6, 2002

Related U.S. Application Data
(60) Provisional application No. 60/303,884, filed on Jul. 10, 2001.

(51) Int. Cl. H02P 9/04; F03B 13/00; F03B 13/10

(52) U.S. Cl. 290/43

(57) ABSTRACT

Today's wind and water turbines employ a variety of solutions to insure a constant operating speed (RPM). These include passive stall, active stall, pitch control and guide vanes. Each of these techniques effectively avoids capture of additional energy in an increasing flow so that rpm's can remain constant. A constant operating speed is necessary for 60 and 50 cycle environments on and off shore. Wind (and water) speeds above a given range are taken out of play in that these solutions do not transform additional energy at higher flow speeds. In a wind assumption the blades are pitched such that less surface is presented to an increasing wind. In a water assumption guide vanes are further closed to deflect the increased flow of water.

The WT/CWC is a new and unique means of controlling operating speed in wind and water turbines. The ability to dynamically change a centrifugal weight by means of jackscrew and guide to control rpm's does permit capture of additional kinetic energy and its transformation to a mechanical force that, in turn, generates electricity. Rpm's are maintained while rolling torque on the low speed shaft increases. As this rolling torque increases additional generator(s) are brought into play at appropriate cut-in intervals.

### SPECIFICATION

This non-provisional application does reference and claim benefit of an earlier provisional application having a Jul. 10, 2001 filing date and application number 60/303,884.

### BACKGROUND OF INVENTION

Today's wind and water turbines employ a variety of solutions to insure a constant operating speed (RPM). These include passive stall, active stall, pitch control and guide vanes. Each of these techniques effectively avoids capture of additional energy in an increasing flow so that rpm's can remain constant. A constant operating speed is necessary for 60 and 50 cycle electrical environments on and off shore. Wind (and water) speeds above a given range are taken out of play in that these solutions do not transform additional energy into electricity at higher flow speeds. In a wind assumption the blades are pitched such that less surface is presented to an increasing wind. In a water assumption guide vanes are further closed to deflect the increased flow of water.

### BRIEF SUMMARY OF INVENTION

The WT/CWC permits the capture and transformation of energy in an increasing flow (wind or water) while maintaining a desired operating speed. It does not, like other systems, avoid or deflect increases in flow to maintain operating speed. As the speed of a flow increases the weights of the CWC are extended. Such extension increases the rolling torque on the low speed shaft while maintaining desired rpm's. This CWC action permits capture and transformation of additional offered kinetic energy.

### BRIEF DESCRIPTION OF THE SEVERAL VIEWS OF THE DRAWINGS

FIG. #1 —side view complete wind system

FIG. #2 —top & side view of centrifugal weight

FIG. #3 —front view of complete wind system

FIG. #4 —top down view of complete water system

In both drawings the CWC has a vertical position relative to rotors & wheels. This is principally for illustrative purpose and incidental to claims made.

### DETAILED DESCRIPTION OF THE INVENTION

The WT/CWC design, which manipulates centrifugal weight to control rotor speed (and consequently generator speed) will deliver more energy as wind (or water) speeds increase while maintaining a desired operating speed (rpm's). At higher wind or water speed increments, additional generators will be brought into play as the foot-pounds of rolling torque on the low speed shaft increase. In a water assumption, operating speed is typically controlled by guide vanes that open and close to regulate the amount of water that flows past the wheel (typical operation of a Francis Wheel). In a water turbine with CWC the low speed shaft would extend onto shore where CWC would then be applied. Only the rotor, low speed shaft and necessary infrastructure would be in the water (see FIG. #4). All other components (CWC/gearbox / generators / control /etc.) would be on shore.

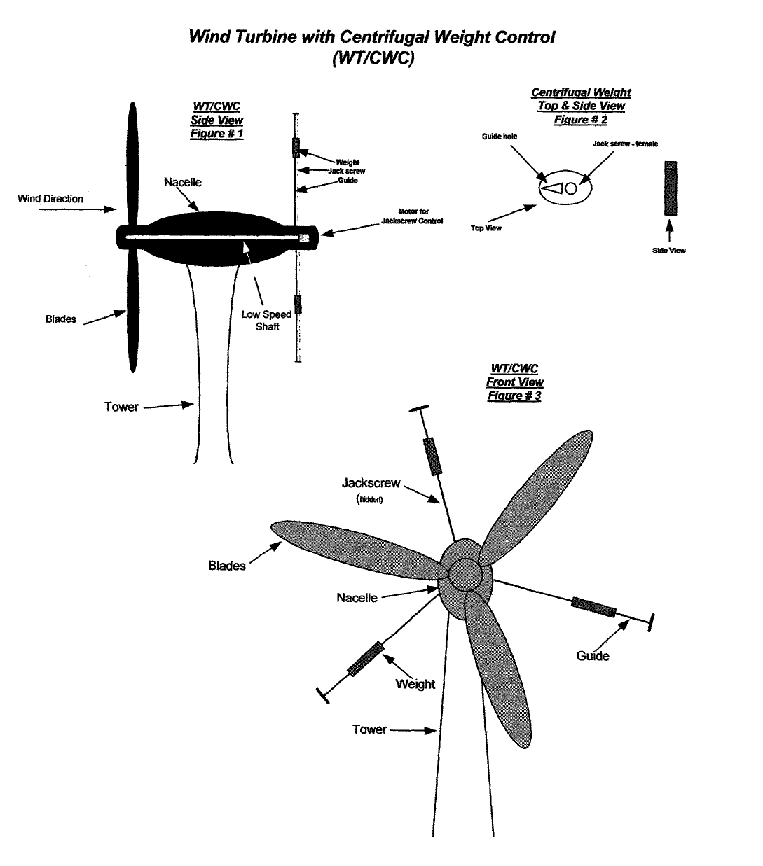

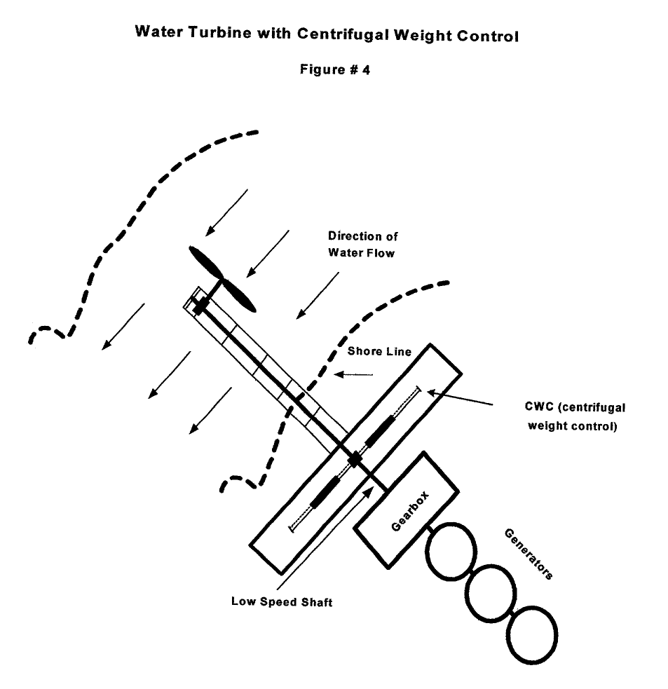

Description of WT/CWC: (See FIGS. 1, 2, & 3)

1. At the far end of an extended low speed shaft are weights that extend up and down on their guides as wind speeds increase or decrease. These weights are on guides and move up and down with a “jack screw” type gear. The guides anchor on a hub that is at the downwind end of the low speed shaft. The guides are simply steel rods on which the weights extend or retract as a function of wind speed. This “controlled action” will deliver a constant rotor speed and increasing foot-pounds of rolling torque as wind speeds increase above minimum (1^{st} cut-in) speed.

2. In an increasing wind, extending weights farther away from the hub delivers an increasing centrifugal force that in turn holds rotor speed constant while delivering more rolling torque. As available rolling torque increases, additional generators are brought into play and greater amounts of electrical energy are realized.

3. The “controlled action” is the synchronous movement of the centrifugal weights closer to or farther from their hub depending on wind speed. The weights, guides and jackscrews have minimal aerodynamic impact. In below figures and in bench test three weights, guides and jackscrews radiate from the hub. Having twice as many may prove to be a more stable and responsive design in full scale.

4. The jackscrews are under motor control that is, in turn, under microprocessor control. Maintaining desired rpm's, weight position and clutch control for 2^{nd} & 3^{rd} cut-in intervals will necessitate re-calibration/modification of existing algorithms that control multiple operations.

1. The claim that merits patent is the integration of the above centrifugal scheme with the traditional design of wind and water turbine technology (less traditional stall, pitch and guide vane methods). Maintaining a constant speed (RPM) with the above discussed centrifugal solution as wind (or water) speeds increase results in increased rolling torque on the low speed shaft that, in turn, permits the introduction of additional generators at 2^{nd} and 3^{rd} cut-in intervals.

2. Controlling rotor speed with a controlled centrifugal force as wind (or water) speeds increase does permit the capture of energies that heretofore were lost. This new design should significantly increase the ability to transform wind (water) energy into electrical energy.

3. The WT/CWC is a new and unique means of controlling operating speed in wind and water turbines. The ability to dynamically change a centrifugal weight by means of jackscrew and guide to control rpm's does permit capture of additional kinetic energy and its transformation to a mechanical force that, in turn, generates electricity. Rpm's are maintained while rolling torque on the low speed shaft increases. As this rolling torque increases additional generator(s) are brought into play at appropriate cut-in intervals.
